(19) United States
(12) Patent Application Publication
(10) Pub. No.: US 2006/0212351 A1
(43) Pub. Date: Sep. 21, 2006

(54) Server apparatus having function of creating website on which advertisement information is automatically displayed, and advertisement information providing system using the server apparatus

(76) Inventor: Yumeto Funahashi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/369,763

(22) Filed: Mar. 8, 2006

(30) Foreign Application Priority Data
Mar. 17, 2005 (JP) 2005-077807

(51) Int. Cl. G06Q 30/00

(52) U.S. Cl. 705/14

(57) ABSTRACT

A server apparatus having a function of creating a website on which advertisement information is automatically displayed, the server apparatus including: a website creation processing unit that converts website editing data into an HTML document and that creates website information including menus corresponding to the website editing data; an advertisement insertion range creation processing unit that creates an advertisement insertion range included in the website, and that includes the advertisement insertion range in the created website information when the created website information is displayed during a website information creation processing performed by the website creation processing unit; a website display unit that displays the website based on the created website information when an access to the created website is acquired; an advertisement information acquisition request unit that outputs advertisement acquisition request information so as to acquire advertisement information inserted into the advertisement insertion range when the information acquisition unit acquires the access to the created website; and an advertisement information display unit that inserts the acquired advertisement information into the advertisement insertion range on the displayed website, and that displays the advertisement information.

### BACKGROUND OF THE INVENTION

1. Field of the Invention

The present invention relates to a server apparatus having a function of creating a website on which advertisement information is automatically displayed, and an advertisement information providing system using this apparatus.

2. Description of the Related Art

Following expansion of a network environment including the Internet, more and more individuals start opening websites on their own.

Further, while highly advanced cellular phones accessible to the Internet are spreading, the number of people who access the Internet from their cellular phones and view websites increases as one of the methods for using the cellular phone.

While the number of occasions for viewing websites in this manner increases and the number of people who view websites increases, a movement of opening websites not only by companies but also by individual is becoming active. Before opening a created website, it is necessary to upload the website to a server of a provider through which a person connects his or her computer to the Internet.

With the view of supporting such creation and opening of a website, many website builder applications for supporting not only creating a website but also supporting uploading of the created website have been commercially available.

To open a website using such a commercially available application and to upload the website, it takes considerable cost.

Meanwhile, it is convenient for an advertiser who wants owners of the highly advanced cellular phones to view advertisement information through the Internet to be able to put the advertisement information on many websites thus opened.

To this end, there is proposed a technique for making it possible to facilitate a series of procedures such as creation and opening of a website, putting an advertisement on many websites opened by individuals and the like, allowing the advertiser to pay advertisement fees to the website owners, and enabling many website viewers such as the owners of highly advanced cellular phones to view advertisement information (see, for example, Japanese Patent Application Laid-Open No. 2002-117156).

However, the conventional technique has the following disadvantages. If a website with an advertisement is to be created, it normally takes lots of labor and time to perform an operation for adding the advertisement to the website for every advertiser. In addition, it is difficult to allocate a different advertisement to a static website once one advertisement is put on the website. Further, if the advertiser is changed to a different advertiser, a website is in the process such as a change in a method for issuing an advertisement, or an advertisement server is down, the advertisement cannot be distributed.

### SUMMARY OF THE INVENTION

It is an object of the present invention to provide a server apparatus that includes a function of creating a website on which advertisement is automatically displayed, that can easily create a website with an advertisement, that can easily allocate a different advertisement, and that can continuously distribute advertisements to the website with the advertisement even if an advertiser is changed or a method for issuing an advertisement is changed, and to provide an advertisement information providing system using this server apparatus.

To attain this object, an advertisement information providing system according to the present invention is constituted by a server apparatus including the following function. The server apparatus having the website creating function according to the present invention is realized by a computer connectable to a wired or wireless network such as the Internet.

This server apparatus is bidirectionally communicably connected to client terminals each realized by a personal computer, a cellular phone, a personal digital assistant (PDA) or the like through a wired or wireless network such as the Internet. In addition, the server apparatus is bidirectionally communicably connected to a second server apparatus, which is a server apparatus that distributes advertisement information, through a wired or wireless network such as the Internet. The second server, which is the server apparatus that distributes the advertisement information, is bidirectionally communicably connected to a third server apparatus, which is an advertiser's server apparatus that distributes the advertisement information, through a wired or wireless network such as the Internet.

A database (hereinafter, sometimes referred to as “DB” in the specification and the drawings) of the server apparatus having the website creating function according to the present invention includes a component DB, a parameter DB, a website editing data DB, a website information DB, and an advertisement information DB.

The component DB is a database that stores a plurality of components that constitute menus on a website, respectively. The parameter DB is a database that stores a plurality of parameters that constitute the respective website menus by combinations of the parameters with the respective components stored in the component DB.

The components correspond to various menus, respectively generally provided in conventionally well-known websites such as a bulletin board system (BBS), an e-mail newsletter, a photo studio, a lottery, and a chat. They are constituent elements for realizing the menu functions, respectively. The parameters refer to constituent elements corresponding to a background, a title, a color, and the like when the respective components function as the menus. Even if the same component is used, a different menu can be made by changing parameters. For example, even if the BBS component is used, a technical topic specific BBS or a conversation BBS can be created by changing parameters.

The website editing data DB is a database that stores website editing data generated by combinations of the components and the parameters fetched from the component DB and the parameter DB, respectively, by a processing operation performed by a website editing data generation processing unit to be described later.

The website information DB is a database that stores website information created by a processing operation performed by a website creation processing unit to be described later.

The advertisement information DB is a database that stores advertisement information provided by an advertiser and inserted into an advertisement insertion range on the website, which range is created by an advertisement insertion range creation processing unit to be described later, by advertisement information display means and second advertisement information display means to be described later.

An arithmetic processing unit of the server apparatus having the website creating function according to the present invention functions as a website editing data generation processing unit, a website creation processing unit, a website insertion range creation processing unit, website display means, advertisement information acquisition request means, advertisement information display means, terminal specifying means, terminal type information output means, a terminal type specifying information transfer processing unit, or the second advertisement information display means under control of a computer program.

The website editing data generation processing unit performs a processing operation for fetching selected components and selected parameters from the component DB and the parameter DB, respectively, for combining the selected components and parameters, and for storing them as the website editing data in the website editing data DB, based on information on the components selected from the component DB and information on the parameters selected from the parameter DB as parameters to be combined with the selected components, both information of which are acquired by the information acquisition unit of the server apparatus having the website creating function according to the present invention.

The website creation processing unit performs a processing operation for converting the website editing data into an HTML document, creating website information including the menus corresponding to the website editing data, and storing the created website information in the website information DB.

The advertisement insertion range creation processing unit performs a processing operation for creating the advertisement insertion range included in a website, and for including the created advertisement insertion range in the website information when the created website information is displayed during a website information creation processing performed by the website creation processing unit.

The website display means performs a processing operation for displaying the website based on the created website information when the information acquisition unit of the server apparatus acquires an access to the created website.

The advertisement information acquisition request means performs a processing operation for outputting advertisement acquisition request information through an information output unit of the server apparatus so as to acquire the advertisement information inserted in the advertisement insertion range when the information acquisition unit of the server apparatus having the website creating function acquires the access to the created website.

The advertisement information display means performs a processing operation for inserting the advertisement information acquired by the information acquisition unit of the server apparatus having the website creating function into the advertisement insertion range on the displayed website, and for displaying the inserted advertisement information.

The terminal specifying means performs a processing operation for specifying a type (e.g., a personal computer or a cellular phone, and in case of the cellular phone, types including a manufacturer name and a machine type for specifying a function of the cellular phone) of a terminal that accesses the website when the information acquisition unit of the server apparatus having the website creating function acquires the access to the website.

The terminal type information output means performs a processing operation for adding information on what type of terminal is accessing the website to the advertisement acquisition request information, by the terminal specifying means, when the advertisement acquisition request information is output through the information output unit of the server apparatus having the website creating function.

In the advertisement information providing system proposed by the present invention, the server apparatus having the website creating function according to the present invention is connected to the second server apparatus configured as follows through the wired or wireless network such as the Internet, as stated above.

The second server apparatus includes a second advertisement information DB that stores advertisement information. An arithmetic processing unit of the second server apparatus functions as advertisement information transmission and output means to be described later in accordance with a computer program.

The second advertisement information DB is provided in a database which the second server apparatus includes. The second advertisement information DB stores the advertisement information provided by the advertiser, transmitted to the server apparatus by the advertisement information transmission and output means based on the advertisement acquisition request information transmitted from the server apparatus having the website creating function, and inserted into the advertisement insertion range on the website, or stores advertisement information to be stored in the advertisement information DB of the server apparatus.

The advertisement information transmission and output means performs a processing operation for transmitting the advertisement information stored in the second advertisement information DB to the server apparatus, which includes the website creating function according to the present invention and which transmits the advertisement acquisition request information, based on the advertisement acquisition request information when an information acquisition unit of the second server apparatus acquires the advertisement acquisition request information transmitted from the server apparatus through the network.

In the advertisement information providing system according to the present invention, the arithmetic processing units of the server apparatus having the website creating function according to the present invention and the second server apparatus function as the terminal type specifying information transfer processing unit and second terminal specifying means that perform processing operations to be described later, respectively, according to a computer program.

The terminal type specifying information transfer processing unit provided in the server apparatus having the website creating function performs a processing operation for adding information for specifying the type of one of the terminals that accesses the website to the advertisement acquisition request information output from the information output unit of the server apparatus when the information acquisition unit of the server apparatus acquires the access to the website.

The second terminal specifying means of the second server apparatus performs a processing operation for specifying the type of one of the terminals that accesses the website, based on the information for specifying the type of one of the terminals that accesses the website, which information is added to the advertisement acquisition request information acquired by the information acquisition unit of the second server apparatus.

The arithmetic processing unit of the second server apparatus further functions as advertisement information extraction means to be described later according to a computer program.

This advertisement information extraction means performs a processing operation for fetching advertisement information corresponding to the type of one of the terminals as the advertisement information to be transmitted by the advertisement information transmission and output means, from the second advertisement information DB based on the information on the type of one of the terminals added to the advertisement acquisition request information acquired by the information acquisition unit of the second server apparatus or based on the information on the type of one of the terminals specified by the second terminal specifying means.

Furthermore, the server apparatus having the website creating function according to the present invention includes the advertisement information DB in the database. The arithmetic processing unit of the server apparatus functions as the second advertisement information display means that performs the following processing operation based on a computer program.

The second advertisement information display means performs a processing operation for inserting the advertisement information stored in the advertisement information DB into the advertisement insertion range on the displayed website when the server apparatus cannot acquire the advertisement information although the advertisement information acquisition request means of the server apparatus having the website creating function according to the present invention outputs the advertisement acquisition request information through the information output unit.

In the advertisement information providing system according to the present invention, as described above, the second server apparatus is connected to the third server apparatus configured as follows through the wired or wireless network such as the Internet.

This third server apparatus includes a third advertisement information DB in its database.

The arithmetic processing unit of the second server apparatus functions as advertisement information conversion means that performs the following processing operation based on a computer program.

The advertisement information conversion means performs a processing operation for converting the acquired information into information in a format corresponding to the website information to be displayed by the server apparatus having the website creating function according to the present invention, and for storing the resultant information in the second advertisement information DB of the second server apparatus when information acquisition unit of the second server apparatus acquires the advertisement information from the third server apparatus.

As mentioned above, the present invention provides the server apparatus having the function that can easily create the website with an advertisement on which advertisement is automatically displayed, can easily allocate a different advertisement, and can continuously distribute advertisements to the website with the advertisement even if the advertiser is changed or a method for issuing the advertisement is changed, and provides the advertisement information providing system using this server apparatus.

### BRIEF DESCRIPTION OF THE DRAWINGS

FIG. 1 is an explanatory view of an example of a schematic configuration of a system when an advertisement information providing system according to the present invention is applied to the system;

FIG. 2 is an explanatory view of a schematic configuration of a server apparatus having a website creating function in the advertisement information providing system according to the present invention;

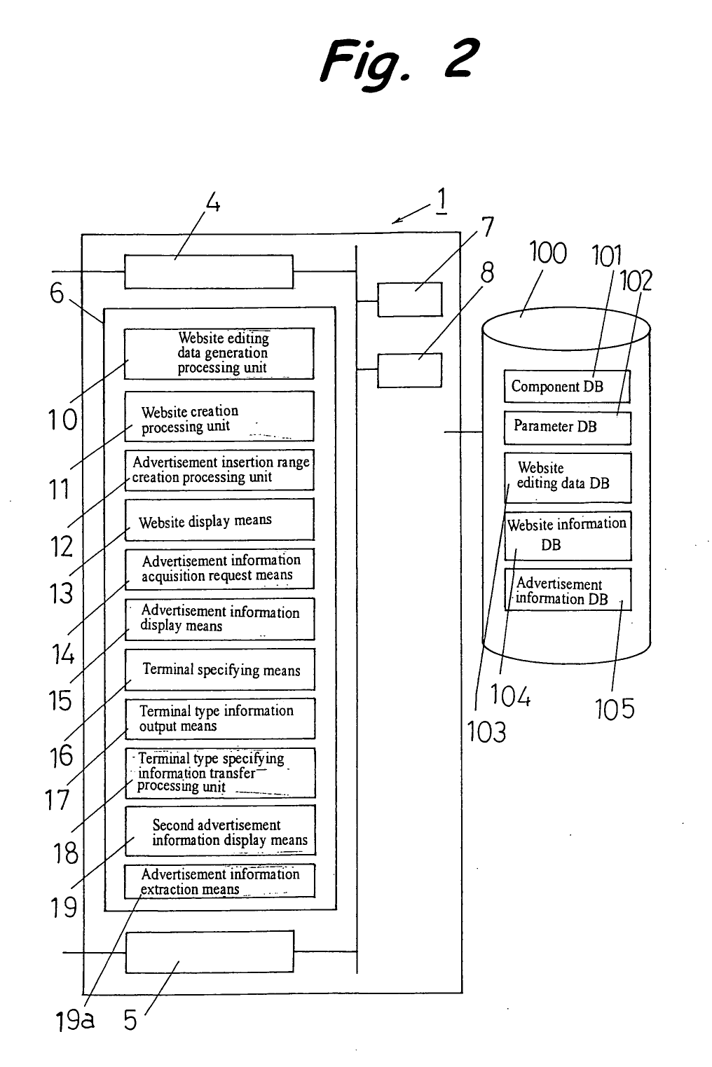

FIG. 3 is an explanatory view of a schematic configuration of a second server apparatus in the advertisement information providing system according to the present invention;

FIG. 4 is a flowchart showing an example of a process of creating a website by the server apparatus having the website creating function according to the present invention and of opening the created website;

FIG. 5 is a block diagram of an example of a process in which a website editing data generation processing unit fetches components and parameters from a component DB and a parameter DB, respectively, combines them, and stores the combinations in a website editing data DB as website editing data;

FIG. 6 is a block diagram of an example of a process of converting the website editing data stored in the website editing data DB into an HTML document, creating website information including a menu corresponding to the website editing data, and storing the created website information in a website information DB;

FIG. 7 is a block diagram of an example of a process of viewing a website with an advertisement in the advertisement information providing system according to the present invention;

FIG. 8 is a block diagram of another example of the process of viewing the website with an advertisement in the advertisement information providing system according to the present invention;

FIG. 9 is an explanatory view of an example of a schematic configuration of the advertisement information providing system according to the present invention when the system is used;

FIG. 10 is an explanatory view of another example of the schematic configuration of the advertisement information providing system according to the present invention when the system is used;

FIG. 11 is a block diagram of an example of a process of viewing the website with an advertisement even if a third server apparatus is down in the advertisement information providing system according to the present invention;

FIG. 12 is a block diagram of an example of a process of viewing the website with an advertisement even if a second server apparatus is down in the advertisement information providing system according to the present invention; and

FIGS. 13A to 13D are block diagrams of a process of viewing the website with an advertisement even if the third server apparatus and the second server apparatus are down in the advertisement information providing system according to the present invention.

### DESCRIPTION OF THE PREFERRED EMBODIMENT

A preferred embodiment of the present invention will be described hereinafter with reference to the accompanying drawings.

A server apparatus 1 having a website creating function according to the present invention is realized by a computer connectable to a wired or wireless network such as the Internet.

This server apparatus 1 includes an information acquisition unit 4 that is connected to the network and that transmits and receives information, an information output unit 5, an arithmetic processing unit 6 including a central processing unit (CPU) and the like, a read only memory (ROM) 7, a random access memory (RAM) 8, and a database 100.

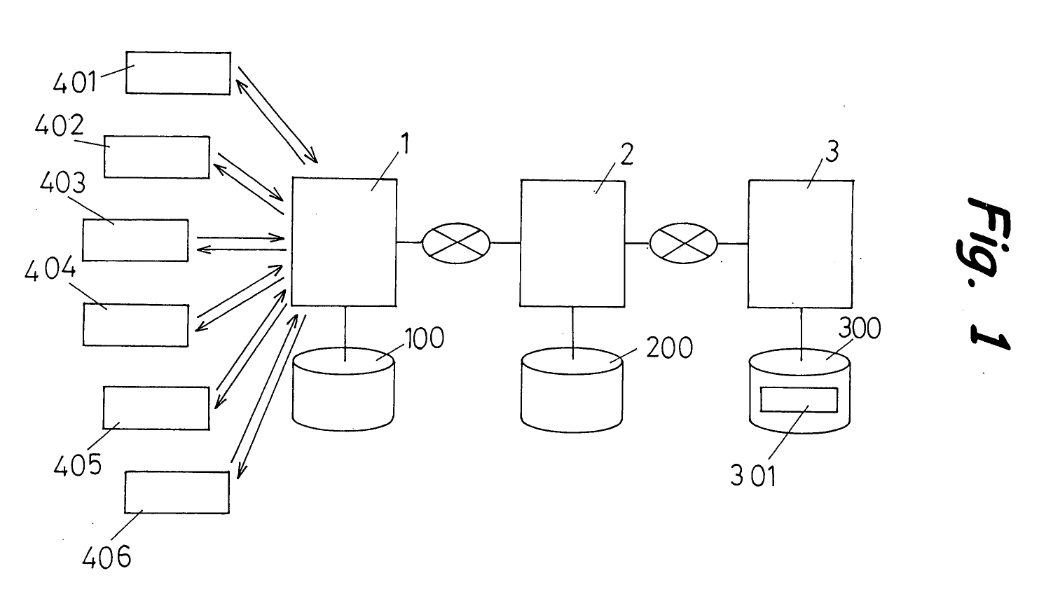

As shown in FIG. 1, this server apparatus 1 is bidirectionally communicably connected to client terminals 401 to 406 each realized by a personal computer, a cellular phone, a personal digital assistant (PDA) or the like through a wired or wireless network such as the Internet. In addition, the server apparatus 1 is bidirectionally communicably connected to a second server apparatus 2, which is a server apparatus that distributes advertisement information, through a wired or wireless network such as the Internet. The second server 2, which is the server apparatus that distributes the advertisement information, is bidirectionally communicably connected to a third server apparatus 3, which is an advertiser's server apparatus that distributes the advertisement information, through a wired or wireless network such as the Internet.

The database 100 includes a component database (DB) 101, a parameter DB 102, a website editing data DB 103, a website information DB 104, and an advertisement information DB 105.

The component DB 101 is a database that stores a plurality of components that constitute menus on a website, respectively.

The parameter DB 102 is a database that stores a plurality of parameters that constitute the respective website menus by combinations of the parameters with the respective components stored in the component DB 101.

The components correspond to various menus, respectively generally provided in conventionally well-known websites such as a bulletin board system (BBS), an e-mail newsletter, a photo studio, a lottery, and a chat. They are constituent elements for realizing the menu functions, respectively. The parameters refer to constituent elements corresponding to a background, a title, a color, and the like when the respective components function as the menus.

Even if the same component is used, a different menu can be made by changing parameters. For example, even if the BBS component is used, a technical topic specific BBS or a conversation BBS can be created by changing parameters.

The website editing data DB 103 is a database that stores website editing data created by combinations of the components and the parameters fetched from the component DB 103 and the parameter DB 102, respectively, by a processing operation performed by a website editing data generation processing unit 10 to be described later.

The website information DB 104 is a database that stores website information created by a processing operation performed by a website creation processing unit 11 to be described later.

The advertisement information DB 105 is a database that stores advertisement information provided by an advertiser and inserted into an advertisement insertion range on the website, which range is created by an advertisement insertion range creation processing unit 12 to be described later, by advertisement information display means 15 and second advertisement information display means 19 to be described later.

The arithmetic processing unit 6 functions as the website editing data generation processing unit 10, the website creation processing unit 11, the website insertion range creation processing unit 12, website display means 13, advertisement information acquisition request means 14, the advertisement information display means 15, terminal specifying means 16, terminal type information output means 17, terminal type specifying information transfer processing unit 18, or the second advertisement information display means 19, performing the following processing operations under control of a computer program.

The website editing data generation processing unit 10 is a computer processing operation unit that performs a processing operation for fetching selected components and selected parameters from the component DB 101 and the parameter DB 102, respectively, for combining the selected components and parameters, and for storing them as the website editing data in the website editing data DB 103, based on information on the components selected from the component DB 101 and information on the parameters selected from the parameter DB 102 as parameters to be combined with the selected components, both information of which are acquired by the information acquisition unit 4.

The website creation processing unit 11 is a computer processing operation unit that performs a processing operation for converting the website editing data into an HTML document, creating website information including the menus corresponding to the website editing data, and storing the created website information in the website information DB 104.

The advertisement insertion range creation processing unit 12 is a computer processing operation unit that performs a processing operation for creating the advertisement insertion range included in a website, and for including the created advertisement insertion range in the website information when the created website information is displayed during the website information creation processing performed by the website creation processing unit 11.

The website display means 13 is a computer processing operation unit that performs a processing operation for displaying the website based on the created website information when the information acquisition unit 4 of the server apparatus 1 acquires an access to the created website.

The advertisement information acquisition request means 14 is a computer processing operation unit that performs a processing operation for outputting advertisement acquisition request information through the information output unit 5 of the server apparatus 1 so as to acquire the advertisement information inserted in the advertisement insertion range when the information acquisition unit 4 of the server apparatus 1 acquires the access to the created website.

The advertisement information display means 15 is a computer processing operation unit that performs a processing operation for inserting the advertisement information acquired by the information acquisition unit 4 of the server apparatus 1 into the advertisement insertion range on the displayed website, and for displaying the inserted advertisement information.

The terminal specifying means 16 is a computer processing operation unit that performs a processing operation for specifying a type (e.g., a personal computer or a cellular phone, and in case of the cellular phone, types including a manufacturer name and a machine type for specifying a function of the cellular phone) of a terminal that accesses the website when the information acquisition unit 4 of the server apparatus 1 acquires the access to the website.

The terminal type information output means 17 is a computer processing operation unit that performs a processing operation for adding information on the type of the terminal specified by the terminal specifying means 16 and accessing the website to the advertisement acquisition request information when the advertisement acquisition request information is output through the information output unit 5 of the server apparatus 1.

In the advertisement information providing system according to the present invention, the server apparatus 1 having the website creating function according to the present invention is connected to the second server apparatus 2 configured as follows through the wired or wireless network such as the Internet.

The second server apparatus 2 includes a second advertisement information DB 201 that stores advertisement information. An arithmetic processing unit 6a of the second server apparatus 2 functions as advertisement information transmission and output means 20 to be described later in accordance with a computer program.

The second advertisement information DB 201 is provided in a database 200 which the second server apparatus 2 includes. The second advertisement information DB 201 stores the advertisement information provided by the advertiser, transmitted to the server apparatus 1 by the advertisement information transmission and output means 20 based on the advertisement acquisition request information transmitted from the server apparatus 1 having the website creating function, and inserted into the advertisement insertion range on the website, or stores advertisement information to be stored in the advertisement information DB 105 of the server apparatus 1.

The advertisement information transmission and output means 20 is a computer processing operation unit that performs a processing operation for transmitting the advertisement information stored in the second advertisement information DB 201 to the server apparatus 1, which has the website creating function according to the present invention and which transmits the advertisement acquisition request information, based on the advertisement acquisition request information when an information acquisition unit 4a of the second server apparatus 2 acquires the advertisement acquisition request information transmitted from the server apparatus 1 through the network.

In the advertisement information providing system according to the present invention, the arithmetic processing units 6 and 6a of the server apparatus 1 having the website creating function according to the present invention and the second server apparatus 2 function as the terminal type specifying information transfer processing unit 18 and second terminal specifying means 21 that performs processing operations to be described later, respectively, according to a computer program.

The terminal type specifying information transfer processing unit 18 provided in the server apparatus 1 having the website creating function is a computer processing operation unit that performs a processing operation for adding information for specifying the type of one of the terminals 401 to 406 and the like that accesses the website to the advertisement acquisition request information output from the information output unit 5 of the server apparatus 1 when the information acquisition unit 4 of the server apparatus 1 acquires the access to the website.

The second terminal specifying means 21 of the second server apparatus 2 is a computer processing operation unit that performs a processing operation for specifying the type of one of the terminals 401 to 406 and the like that accesses the website, based on the information for specifying the type of one of the terminals 401 to 406 and the like that accesses the website, which information is added to the advertisement acquisition request information acquired by the information acquisition unit 4a of the second server apparatus 2.

The arithmetic processing unit 6a of the second server apparatus 21 further functions as advertisement information extraction means 22 to be described later according to a computer program.

This advertisement information extraction means 22 is a computer processing operation unit that performs a processing operation for fetching advertisement information corresponding to the type of one of the terminals 401 to 406 as the advertisement information to be transmitted by the advertisement information transmission and output means 20, from the second advertisement information DB 201 based on the information on the type of one of the terminals 401 to 406 added to the advertisement acquisition request information acquired by the information acquisition unit 4a of the second server apparatus 2 or based on the information on the type of one of the terminals 401 to 406 specified by the second terminal specifying means 21.

Furthermore, the server apparatus 1 having the website creating function according to the present invention includes the advertisement information DB 105 in the database 100. The arithmetic processing unit 6 of the server apparatus 1 functions as the second advertisement information display means 19 that performs the following processing operation based on a computer program.

The second advertisement information display means 19 is a computer processing operation unit that performs a processing operation for inserting the advertisement information stored in the advertisement information DB 105 into the advertisement insertion range on the displayed website when the server apparatus 1 cannot acquire the advertisement information although the advertisement information acquisition request means 14 of the server apparatus 1 having the website creating function according to the present invention outputs the advertisement acquisition request information through the information output unit 5.

In the advertisement information providing system according to the present invention, the second server apparatus 2 is connected to the third server apparatus 3 configured as follows through the wired or wireless network such as the Internet.

This third server apparatus 3 includes a third advertisement information DB 301 in its database 300.

The arithmetic processing unit 6a of the second server apparatus 2 functions as advertisement information conversion means 23 that performs the following processing operation based on a computer program.

The advertisement information conversion means 23 is a computer processing operation unit that performs a processing operation for converting the acquired information into information in a format corresponding to the website information displayed by the server apparatus 1 having the website creating function according to the present invention, and for storing the resultant information in the second advertisement information DB 202 of the second server apparatus 2 when the information acquisition unit 4a of the second server apparatus 2 acquires the advertisement information from the third server apparatus 3.

(Creation and Opening of Website)

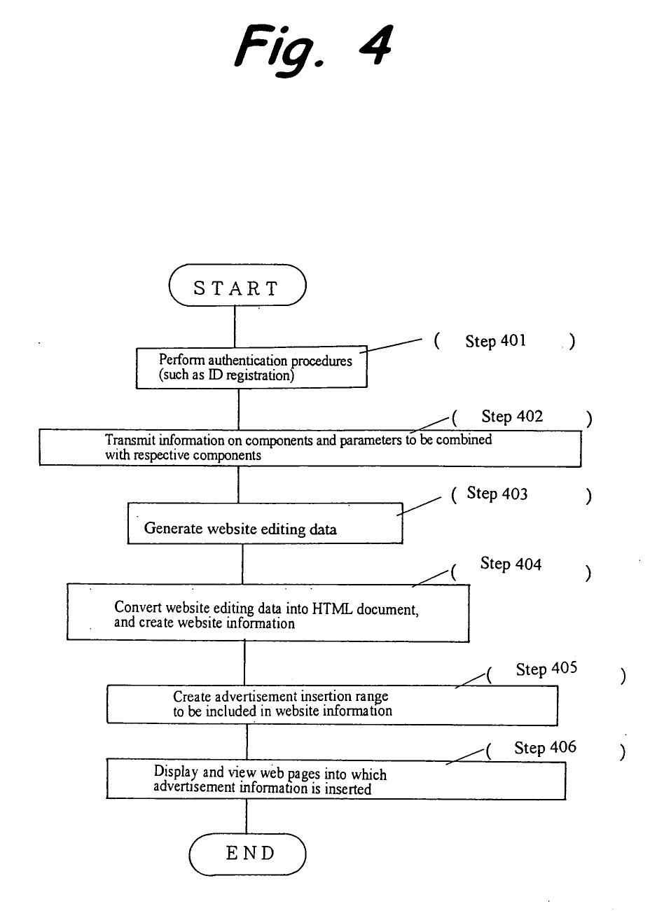

A process of creating a website and opening the created website by the server apparatus 1 having the website creating function according to the present invention will next be described with reference to FIG. 4.

For instance, an owner who has asked a provider that provides the advertisement information providing system according to the present invention to provide services buys the server apparatus 1 having the website creating function according to the present invention or uses the server apparatus 1 on a rental basis or the like. In addition, the owner installs the server apparatus 1 on the wired or wireless network such as the Internet.

A user who plans to create and open a website by the server apparatus 1 having the website creating function according to the present invention accesses the server apparatus 1 installed on the network by the owner from his or her own personal computer or the like, and starts a website creating operation.

First, after carrying out predetermined authentication procedures such as ID registration (step 401), the user transmits information on the components selected from the component DB 101 and information on the parameters selected from the parameter DB 102 as parameters to be combined with the selected components, to the server apparatus 1 from his or her own personal computer (step 402).

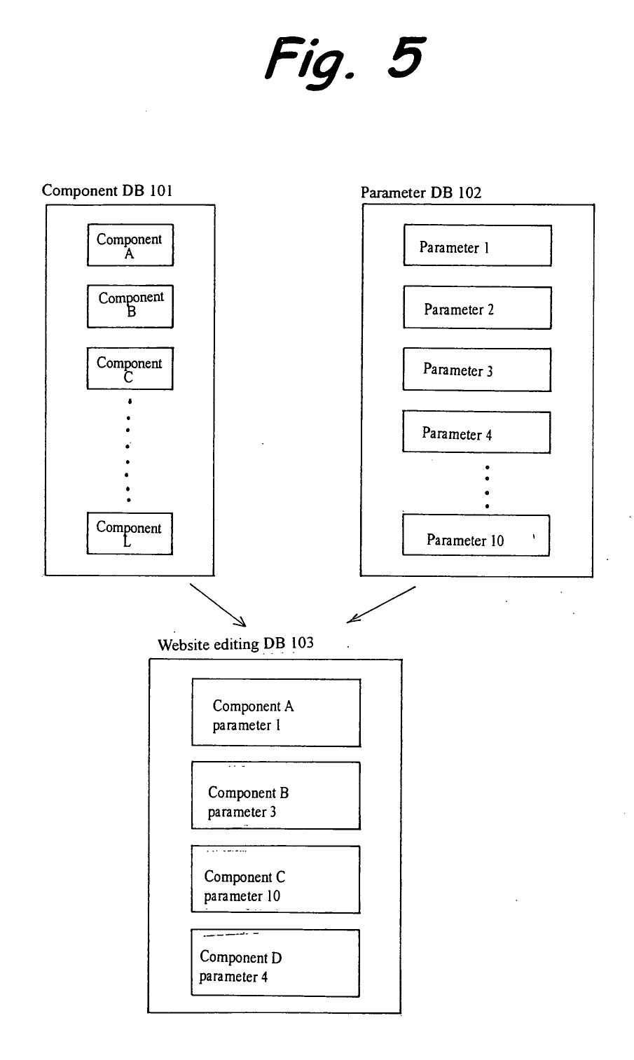

In the server apparatus 1, when the information acquisition unit 4 acquires the information, the website editing data generation processing unit 10 performs the processing operation for fetching the selected components and the selected parameters from the component DB 101 and the parameter DB 102, respectively, combining the selected components and parameters, and storing them in the website editing data DB 103 as the website editing data (step 403) (FIGS. 4 and 5).

The component DB 101 provided in the server apparatus 1 according to the present invention stores the constituent elements that correspond to a plurality of components constituting the respective menus on the website, that is, constituent elements corresponding to various menus, respectively generally provided in conventionally well-known websites such as a BBS, an e-mail newsletter, a photo studio, a lottery, and a chat, and realizing menu functions. Further, the parameter DB 102 includes a plurality of parameters combined with the components stored in the component DB 101 and constituting the respective menus on the website, that is, constituent elements corresponding to, for example, a background, a title, and a color used when the respective components function as the menus. The website editing data DB 103 stores the website editing data generated by combinations of the components and the parameters fetched from the component DB 101 and the parameter DB 102, respectively, by the processing operation performed by the website editing data generation processing unit 10 (FIG. 5).

As can be seen, in step 403, the website editing data generation processing unit 10 fetches and combines the selected components and the selected parameters from the component DB 101 and the parameter DB 102, respectively, based on the information acquired by the information acquisition unit 4 of the server apparatus 1, and stores them in the website editing data DB 103 as the website editing data (FIG. 5).

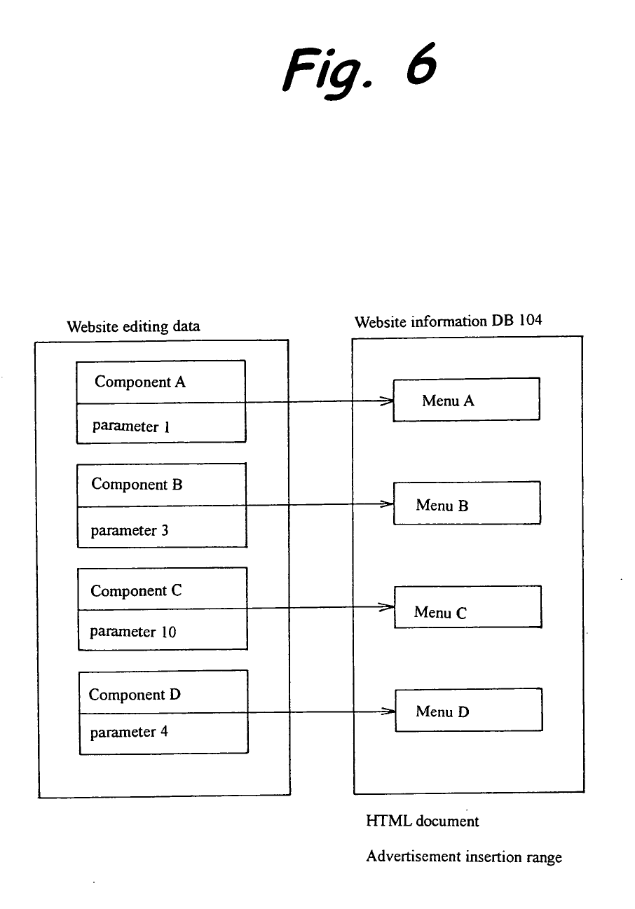

Next, the website creation processing unit 11 converts the website editing data stored in the website editing data DB 103 into a HTML document, creates website information including the menu corresponding to the website editing data, and stores the created website information in the website information DB 104 (step 404) (FIGS. 4 and 6).

The website information DB 104 provided in the server apparatus 1 is a database that stores the website information generated by the processing operation performed by the website creation processing unit 11.

The server apparatus according to the present invention can create a different menu by changing parameters even if the same components are used. For instance, even if the components of the BBS are used, a technical topic specific BBS or a conversation BBS can be created by changing parameters. The components include functions for creating various menus. Therefore, a person who accesses the server apparatus 1 according to the present invention to create a website can create a highly advanced website only by selecting components and parameters. In addition, as described above, the person can create a website even without knowledge of the HTML document.

If the website creation processing unit 11 performs the website information creation processing, the advertisement insertion range creation processing unit 12 performs the processing for creating the advertisement insertion range on the website when the created website information is displayed, and for including the created advertisement insertion range in the website information (step 405) (FIGS. 4 and 6).

Through the above-described process, the website is completed.

If a person who is to view the website thus completed accesses the server apparatus 1 through the network from one of the terminals 401 to 406 and the like and the information acquisition unit 4 of the server apparatus 1 acquires the information, the website display means 13 performs the processing for displaying the website based on the thus created website information stored in the website information DB 104 (step 405).

Further, if the person who is to view the completed website accesses the server apparatus I through the network from one of the terminals 401 to 406 and the like and the information acquisition unit 4 of the server apparatus 1 acquires the information, the advertisement information acquisition request means 14 outputs the advertisement acquisition request information through the information output unit 5 of the server apparatus 1 so as to acquire the advertisement information inserted into the advertisement insertion range (step 406). The advertisement information display means 15 inserts the advertisement information acquired by the information acquisition unit 4 of the server apparatus 1 into the advertisement insertion range of the displayed website and displays the inserted advertisement information (step 406).

Thus, the created website is opened (web pages with an advertisement are opened).

(Insertion of Advertisement Information into Advertisement Insertion Range of Opened Website)

In the advertisement information providing system according to the present invention, the server apparatus 1 having the website creating function according to the present invention is connected to the second server apparatus 2 through the wired or wireless network such as the Internet as shown in FIG. 1.

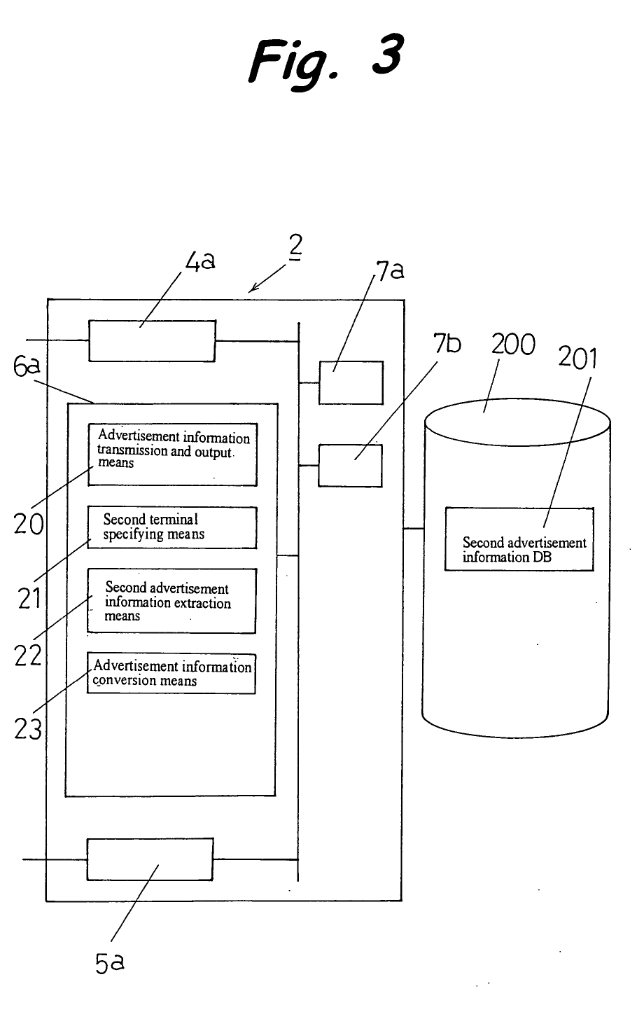

The second server apparatus 2 is installed by the provider that provides the advertisement information providing system according to the present invention on the wired or wireless network such as the Internet. As shown in FIG. 3, the second server apparatus 2 includes the second advertisement information DB 201 that stores the advertisement information. The arithmetic processing unit 6a of this second server apparatus 2 functions as the advertisement information transmission and output means 20 to be described below according to a computer program.

If the information acquisition unit 4a of the second server apparatus 2 acquires the advertisement acquisition request information transmitted from the server apparatus 1 through the network, the advertisement information transmission and output means 20 performs the processing operation for transmitting the advertisement information stored in the second advertisement information DB 201 to the server apparatus 1 which transmits the advertisement acquisition request information, based on the advertisement acquisition request information.

As can be seen, the second advertisement information DB 201 included in the database 200 of the second server apparatus 2 is a database that stores the advertisement information provided by the advertiser, transmitted to the server apparatus 1 by the advertisement information transmission and output means 20 based on the advertisement acquisition request information transmitted from the server apparatus 1 having the website creating function, and inserted into the advertisement insertion range of the website, or the advertisement information to be stored in the advertisement information DB 105 of the server apparatus 1.

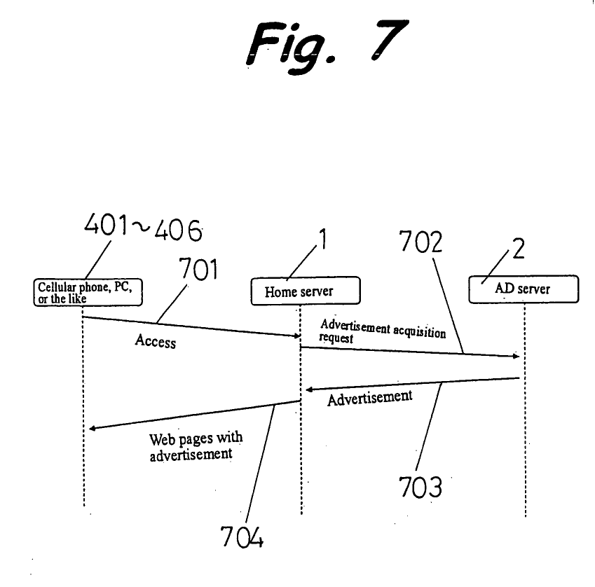

This process will be described with reference to FIG. 7.

A client accesses the server apparatus 1 from one of the terminals 401 to 406 and the like through the network and wants to view a website (step 701). Then, the advertisement information acquisition request means 14 of the server apparatus 1 outputs the advertisement acquisition request information to the second server apparatus 2 through the information output unit 5 of the server apparatus 1 so as to acquire the advertisement information inserted into the advertisement insertion range (step 702). In response to this, the advertisement information transmission and output means 20 of the second server apparatus 2 transmits the advertisement information stored in the second advertisement DB 201 to the server apparatus 1 that transmits the advertisement acquisition request information, based on the advertisement acquisition request information (step 703).

In parallel to the processing (step 405) performed by the website display means 13 of the server apparatus 1 for displaying the website based on the website information thus created and stored in the website information data DB 104, the advertisement information display means 15 of the server apparatus 1 performs the processing for inserting the advertisement information transmitted from the second server apparatus 2 through the network into the website insertion range on the displayed website and for displaying the inserted advertisement information (step 407). The client who operates one of the terminals 401 to 406 and the like views the website thus created (web pages with an advertisement) (step 703).

At the time of the processing (step 405) performed by the website display means 13 of the server apparatus 1 for displaying the website based on the website information stored in the website information data DB 104, and the processing (step 407) performed by the advertisement information display means 15 for inserting the advertisement information into the advertisement insertion frame on the displayed website and for displaying the inserted advertisement information, the arithmetic processing unit 6 of the server apparatus 1 performs a processing for registering and storing the advertisement information inserted into the advertisement insertion range in the advertisement information DB 105 of the server apparatus 1 according to the computer program.

(Opening of Advertisement Information Suitable for Function of Cellular Phone)

If the website is viewed through a cellular phone, it is required to change the advertisement information into information in a format in which the advertisement information can be easily displayed in accordance with the function of one of the terminals 401 to 406 and the like used by the client. For instance, a processing for reducing a banner size is required.

The arithmetic processing unit 6 of the server apparatus 1 functions as the terminal specifying means 16, the terminal type information output means 17 or the terminal type specifying information transfer processing unit 18 that performs the following processing operation according to a computer program. In addition, the arithmetic processing unit 6a of the second server apparatus 2 functions as the second advertisement information extraction means 22 or the second terminal specifying means 21 that performs the following processing operation according to a computer program.

The terminal specifying means 16 performs the processing operation for specifying the type (e.g., a personal computer or a cellular phone, and in case of the cellular phone, a manufacturer name and a machine type for specifying the function of the cellular phone) of one of the terminals 401 to 406 and the like that accesses the website when the information acquisition unit 4 of the server apparatus 1 acquires the access to the website.

The terminal type information output means 17 of the server apparatus 1 performs the processing operation for adding information on the type of one of the terminals 401 to 406 and the like that accesses the website and that is specified by the terminal specifying means 16 to the advertisement acquisition request information when the advertisement acquisition request information is output through the information output unit 5 of the server apparatus 1.

The terminal type specifying information transfer processing unit 18 provided in the server apparatus 1 having the website creating function performs the processing operation for adding information for specifying the type of one of the terminals 401 to 406 and the like that accesses the website to the advertisement acquisition request information output from the information output unit 5 of the server apparatus 1 when the information acquisition unit 4 of the server apparatus 1 acquires the access to the website.

As can be seen, if the server apparatus 1 having the website creating function includes, for example, the terminal specifying means 16 and the terminal type information output means 17, the processing for specifying the type (e.g., a personal computer or a cellular phone, and in case of the cellular phone, a manufacturer name and a machine type for specifying the function of the cellular phone) of one of the terminals 401 to 406 and the like that accesses the website when the information acquisition unit 4 of the server apparatus 1 acquires the access to the website, and the processing for adding the information on the type of one of the terminals 401 to 406 and the like that accesses the website and that is specified by the terminal specifying means 16 to the advertisement acquisition request information when the advertisement acquisition request information is output through the information output unit 5 of the server apparatus 1 are performed.

Further, if the server apparatus 1 having the website creating function includes the terminal type specifying information transfer processing unit 18, the processing for adding the information for specifying the type of one of the terminals 401 to 406 and the like that accesses the website to the advertisement acquisition request information output from the information output unit 5 of the server apparatus 1 when the information acquisition unit 4 of the server apparatus 1 acquires the access to the website is performed.

Meanwhile, the second advertisement information extraction means 22 of the second server apparatus 2 is the computer processing operation unit that performs the processing operation for fetching the advertisement information corresponding to the type of one of the terminals 401 to 406, e.g., the advertisement information subjected to processings such as a reduction in banner size according to the function of one of the terminals 401 to 406 used by the client so as to have the format suitable to display the advertisement information on the terminal used by the client as the advertisement information to be transmitted by the advertisement information transmission and output means 20 from the second advertisement information DB 201 based on the information on the type of one of the terminals 401 to 406 added to the advertisement acquisition request information acquired by the information acquisition unit 4a of the second server apparatus 2 or based on the information on the type of one of the terminals 401 to 406 specified by the second terminal specifying means 21.

Therefore, if the server apparatus 1 having the website creating function includes the terminal specifying means 16 and the terminal type information output means 17, and the information for specifying the type of one of the terminals 401 to 406 used by the client and accessing the server apparatus 1 is added to the advertisement acquisition request information transmitted from the server apparatus 1 to the second server apparatus 2, then the second advertisement information extraction means 22 provided in the second server apparatus 2 performs the above-stated processing operations, and the advertisement information transmission and output means 20 transmits the extracted advertisement information to the server apparatus 1. As a result, the client who accesses the server apparatus 1 using one of the terminals 401 to 406 and who wants to view the website can view the website into which the advertisement information having the format suitable to display the advertisement information on the client's terminal 401 or the like is inserted.

At the time of the processing (step 405) performed by the website display means 13 of the server apparatus 1 for displaying the website based on the website information stored in the website information DB 104, and the processing (step 407) performed by the advertisement information display means 15 for inserting the advertisement information into the advertisement insertion range on the displayed website and for displaying the advertisement information, the arithmetic processing unit 6 of the server apparatus 1 performs a processing for registering the advertisement information inserted into the advertisement insertion range and the information for specifying the type of one of the terminals 401 to 406 used by the client and accessing the server apparatus 1 while associating them with each other, and for storing the information in the advertisement information DB 105 of the server apparatus 1 according to the computer program.

The second terminal specifying means 21 of the second server apparatus 2 is a computer processing operation unit that performs a processing operation for specifying the type of one of the terminals 401 to 406 and the like that accesses the website, based on the information for specifying the type of one of the terminals 401 to 406 and the like that accesses the website, which information is added to the advertisement acquisition request information acquired by the information acquisition unit 4a of the second server apparatus 2.

Therefore, if the server apparatus 1 having the website creating function includes the terminal type specifying information transfer processing unit 18, the information for specifying the type of one of the terminals 401 to 406 and the like that accesses the server apparatus 1 is added to the advertisement acquisition request information acquired by the second server apparatus 2. Due to this, the second terminal specifying means 21 of the second server 2 performs the processing for specifying the type of one of the terminals 401 to 406 and the like that accesses the server apparatus 1 based on the information for specifying the type of one of the terminals 401 to 406 and the like. The second advertisement information extraction means 22 of the second server apparatus 2 then performs the processing for fetching the advertisement information corresponding to the type of one of the terminals 401 to 406 from the second advertisement information DB 201 as the advertisement information to be transmitted by the advertisement information transmission and output means 20 based on the information on the type of one of the terminals 401 to 406 that accesses the server apparatus 1. The advertisement information transmission and output means 20 transmits the extracted advertisement information to the server apparatus 1. As a result, the client who accesses the server apparatus 1 using one of the terminals 401 to 406 and who wants to view the website can view the website into which the advertisement information having the format suitable to display the advertisement information on the client's terminal 401 or the like is inserted.

At the time of the processing (step 405) performed by the website display means 13 of the server apparatus 1 for displaying the website based on the website information stored in the website information DB 104, and the processing (step 407) performed by the advertisement information display means 15 for inserting the advertisement information into the advertisement insertion range on the website and for displaying the advertisement information, the arithmetic processing unit 6 of the server apparatus 1 performs the processing for registering the advertisement information inserted into the advertisement insertion range and the information for specifying the type of one of the terminals 401 to 406 used by the client and accessing the server apparatus 1 while associating them with each other, and for storing the information in the advertisement information DB 105 of the server apparatus 1 according to the computer program.

(Insertion of Advertisement Information into Advertisement Insertion Range Following Conversion of Advertisement Information for Opening, Storing Advertisement Information, and Opening of Website)

In the advertisement information providing system according to the present invention, the second server apparatus 2 is connected to the third server apparatus 3 configured as follows through the wired or wireless network such as the Internet. This third server apparatus 3 is installed on the wired or wireless network such as the Internet by, for example, an advertiser, and stores the advertisement information provided by the advertiser in a third advertisement information DB 301 provided in the database 300.

The arithmetic processing unit 6a of the second server apparatus 2 functions as the advertisement information conversion means 23 that performs the following processing operation based on a computer program.

When the information acquisition unit 4a of the second server apparatus 2 acquires the advertisement information from the third server apparatus 3, the advertisement information conversion means 23 performs the processing operation for converting the acquired advertisement information into information in the format corresponding to the website information displayed by the server apparatus 1 having the website creating function according to the present invention, that is, into the advertisement information corresponding to the type of one of the terminals 401 to 406 used by the client and accessing the server apparatus 1 to view the website, e.g., the advertisement information subjected to the processings such as the reduction in banner size according to the function of one of the terminals 401 to 406 used by the client so as to have the format suitable to display the information on the terminal used by the client, and for storing the resultant information in the second advertisement information DB 202 of the second server apparatus 2.

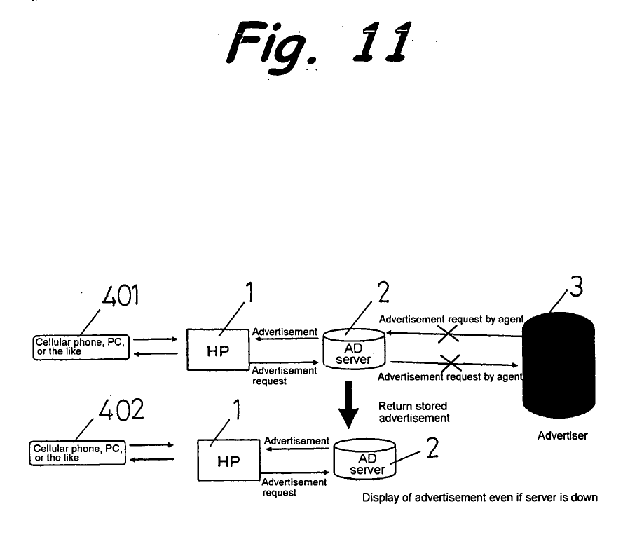

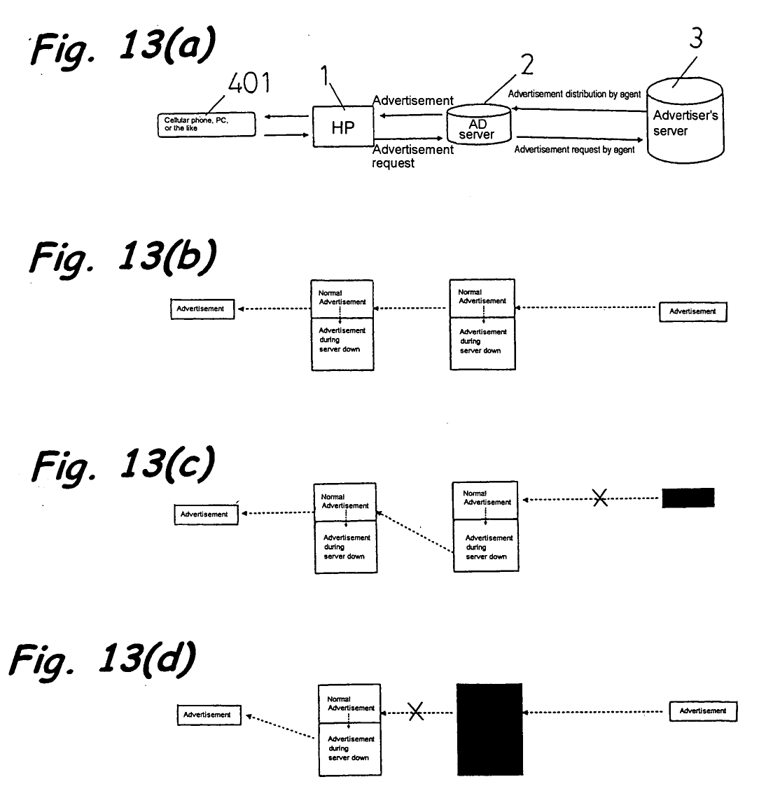

As a result, as shown in FIG. 13A, for example, the client terminal 401 or the like accesses the server apparatus 1, the server apparatus 1 fetches the advertisement information from the second server apparatus 2, and then the second server apparatus 2 fetches the advertisement information from the third server apparatus 3. The advertisement information output from the third server apparatus 3 is transmitted to the server apparatus 1 through the second server apparatus 2. The advertisement information can be inserted into the website viewed by the client using the terminal 401 or the like. Further, as shown in FIG. 11, if the second server apparatus 2 cannot receive the advertisement information from the third server apparatus 3 due to the down of the third server apparatus 3 or the like, the advertisement information stored in the second advertisement information DB 202 of the second server apparatus 2 can be used as the advertisement information inserted into the website viewed by the client using the terminal 401 or the like.

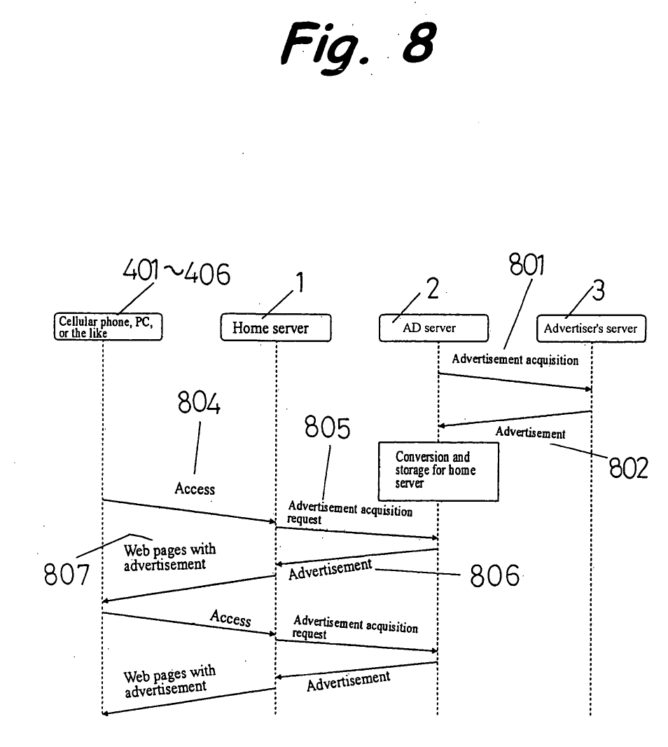

The process of accessing the third server apparatus 3, which is the advertiser's server apparatus, from the second server apparatus 2, which is the server apparatus of the provider that provides the advertisement information providing system according to the present invention, acquiring the advertisement information, and allowing the advertisement information to be viewed by the client's terminal 401 or the like that accesses the server apparatus 1 is performed as shown in, for example, FIG. 8.

First, the second server apparatus 2, which is the provider's server apparatus, accesses the third server apparatus 3, which is the advertiser's server apparatus, and requests the third server apparatus 3 to acquire the advertisement information (step 801). In response to the request, advertisement information transmission and output means (not shown) provided in the third server apparatus 3 transmits the advertisement information stored in the third advertisement information DB 301 provided in the database 300 to the second server apparatus 2 (step 802).

In the second server apparatus 2, the advertisement information conversion means 23 performs the processing for converting the advertisement information acquired from the third server apparatus 3 into advertisement information suitable for the website information displayed by the server apparatus 1, that is, into advertisement information corresponding to the type of one of the terminals 401 to 406 used by the client and accessing the server apparatus 1 to view the website, e.g., the advertisement information subjected to processings such as the reduction in banner size according to the function of one of the terminals 401 to 406 used by the client so as to have the format suitable to display the advertisement information on the client's terminal, and for storing the resultant information in the second advertisement information DB 202 of the second server apparatus 2 (step 803).

Thereafter, the same process described with reference to FIG. 7 is performed. Namely, the client accesses the first server apparatus 1 through the network from one of the terminals 401 to 406 and wants to view the website (step 804). Then, the advertisement information acquisition request means 14 of the server apparatus 1 outputs the advertisement information to the second server apparatus 2 through the information output unit 5 of the server apparatus 1 so as to acquire the advertisement information inserted into the advertisement insertion range (step 805). In response to this, the advertisement information transmission and output means 20 of the second server apparatus 2 transmits the advertisement information stored in the second advertisement information DB 201 to the server apparatus 1 according to the present invention that transmits the advertisement acquisition request information based on the advertisement acquisition request information (step 806).

In parallel to the processing (step 405) performed by the website display means 13 of the server apparatus 1 for displaying the website based on the website information thus created and stored in the website information DB 104, the advertisement information display means 15 of the server apparatus 1 performs the processing for inserting the advertisement information transmitted from the second server apparatus 2 through the network into the advertisement insertion range on the displayed website, and for displaying the advertisement information (step 407). In addition, the client who operates one of the terminals 401 to 406 views the created website (web pages with the advertisement) (step 807).

(Opening of Advertisement Information if Second Server Apparatus is Down)

In the advertisement information providing system according to the present invention, the arithmetic processing unit 6 of the server apparatus 1 having the website creating function according to the present invention functions as the second advertisement information display means 19 that performs the following processing operation based on the computer program.

This second advertisement information display means 19 performs a processing for inserting the advertisement information stored in the advertisement information DB 105 into the advertisement insertion range on the displayed website, and for displaying the advertisement information if the server apparatus 1 having the website creating function according to the present invention cannot acquire the advertisement information although the advertisement information acquisition request means 14 of the server apparatus 1 outputs the advertisement acquisition request information through the information output unit 5.

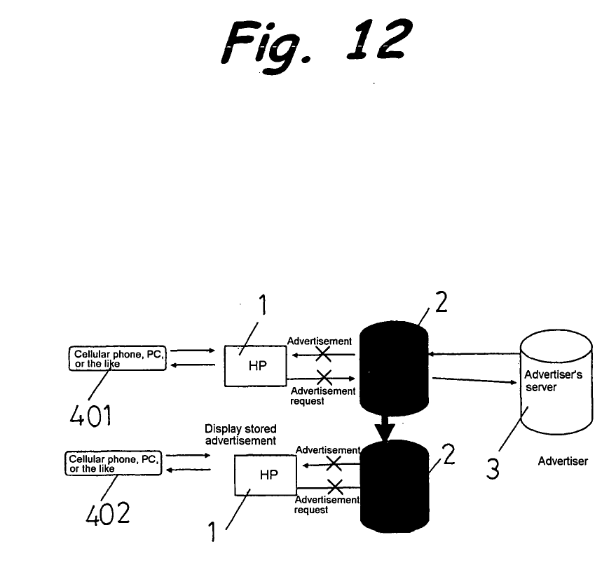

As a result of the processing, as shown in FIG. 12, for example, if the client terminal 401 or the like accesses the server apparatus 1 but the server apparatus 1 cannot receive the advertisement information from the second server apparatus 2 due to the down of the second server 2 or the like, the advertisement information stored in the advertisement information DB 105 of the server apparatus 1 can be used as the advertisement information inserted into the website viewed by the client using the terminal 401 or the like.

FIGS. 13A to 13D are collective explanatory views of the functions of the system according to the present invention described above with reference to FIGS. 11 and 12. Normally, as shown in FIG. 13A, the client terminal 401 or the like accesses the server apparatus 1, and the server apparatus 1 fetches the advertisement information from the second server apparatus 2. The second server apparatus 2 then fetches the advertisement information from the third server apparatus 3, and the advertisement information output from the third server apparatus 3 is transmitted to the server apparatus 1 through the second server apparatus 2. In addition, the advertisement information is inserted into the website viewed by the client using the terminal 401 or the like.

At this time, as shown in FIG. 13B, the second server apparatus 2 and the server apparatus 1 perform processings for storing the advertisement information in the second advertisement information DB 201 and the advertisement information DB 105, respectively, so as to be used when some server is down.

FIG. 13C is an explanatory view of an instance in which if the second server 2 cannot receive the advertisement information from the third server apparatus 3 due to the down of the third server 3 or the like, the advertisement information (the advertisement information for use during server down) stored in the second advertisement information DB 201 of the second server apparatus 2 is used as the advertisement information inserted into the website viewed by the client using the terminal 401 or the like.

FIG. 13D is an explanatory view of an instance in which if the client's terminal 401 or the like accesses the server apparatus 1 but the server apparatus 1 cannot receive the advertisement information from the second server apparatus 2 due to the down of the second server 2 or the like, the advertisement information (the advertisement information for use during server down) stored in the advertisement information DB 105 of the server apparatus 1 is used as the advertisement information inserted into the website viewed by the client using the terminal 401 or the like.

The arithmetic processing unit 6 of the server apparatus 1 functions as advertisement information extraction means 19a that performs the following processing according to a computer program.

This advertisement information extraction means 19a is a computer processing operation unit that performs a processing operation for fetching the advertisement information corresponding to the type of one of the terminals 401 to 406, e.g., the advertisement information subjected to processings such as the reduction in banner size according to the function of the client terminal 401 or the like so as to have the format suitable to display the advertisement information on the terminal used by the client from the advertisement information DB 105 as the advertisement information inserted into the advertisement insertion range by the advertisement information display means 15, based on the information on the type (e.g., a personal computer or a cellular phone, and in case of the cellular phone, a manufacturer name and a machine type for specifying the function of the cellular phone) of one of the terminals 401 to 406 and the like that accesses the server apparatus 1, which type is specified by the processing performed by the terminal specifying means 16 of the server apparatus 1.

Therefore, even if the server apparatus 1 cannot receive the advertisement information from the second server apparatus 2 due to the down of the second server apparatus 2 or the like, and the advertisement information (the advertisement information for use during server down) stored in the advertisement information DB 105 of the server apparatus 1 is used as the advertisement information inserted into the website viewed by the client using the terminal 401 or the like, then the client who wants to view the website can view the website into which the advertisement information in the format suitable to display the advertisement information on the client's terminal 401 or the like is inserted.

The preferred embodiment of the present invention has been described so far. However, the present invention is not limited to the embodiment but various changes and modifications can be made of the present invention within the technical scope grasped from claims of the present invention.

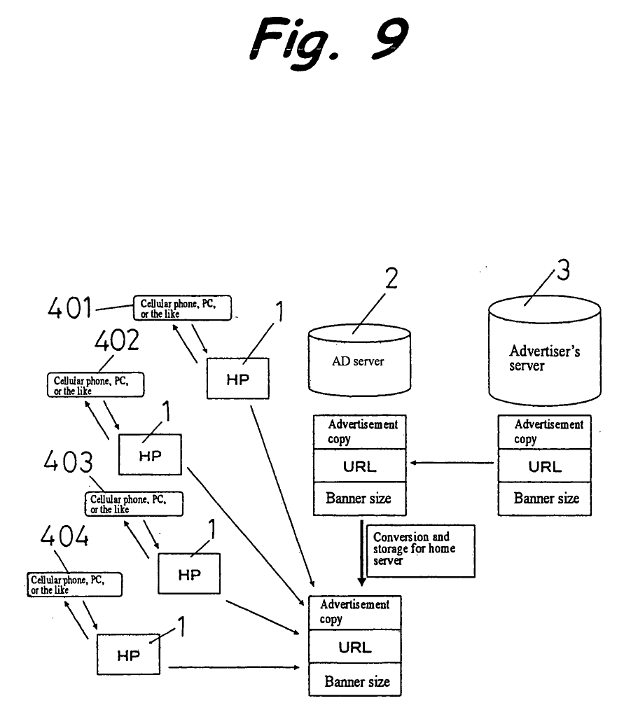

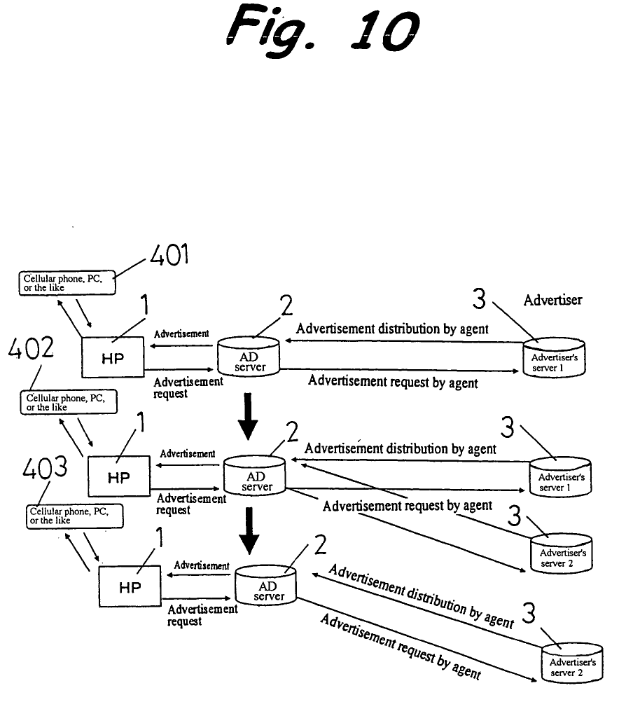

For instance, FIGS. 9 and 10 are explanatory views of the schematic configuration of the advertisement information providing system according to the present invention. In the advertisement information providing system according to the present invention, the user who buys the server apparatus 1 having the website creating function according to the present invention from the provider that provides the advertisement information providing system according to the present invention or uses the server apparatus 1 on a rental basis or the like installs the server apparatus 1 on the network in a connectable manner, and the user who accesses the server apparatus 1 easily creates a website using the functions of the server apparatus 1. The advertisement information is provided to this website from the second server apparatus 2 which the provider that provides the advertisement information providing system according to the present invention installs on the network in a connectable manner. If the client who is to view the website accesses the website from the server 401 or the like, the advertisement is automatically inserted into the website and displayed. Further, the provider that provides the advertisement information providing system according to the present invention can collect advertisement information from the advertiser who wants to open the advertisement information in a wide range by paying fees.

Conventionally, to create and open a website on one's own is accompanied by not only various technical difficulties but also cost burden. According to the advertisement information providing system of the present invention, by contrast, the advertisement information provided by the provider that provides the advertisement information providing system according to the present invention, and that collects the advertisement information from the advertiser that wants to open the advertisement to the public in a wide range by paying fees is automatically inserted into the website viewed by the client. Therefore, the user who buys the server apparatus 1 from the provider that provides the advertisement information providing system according to the present invention or uses the server apparatus 1 on a rental basis or the like can collect a value in compensation for thus opening the advertisement information to the public from the provider that provides the advertisement information providing system according to the present invention. As a result, the user who accesses the server apparatus 1 and who easily creates his or her own website using the functions of the server apparatus 1 can create and open the website without need of special cost burden.

Although preferable embodiments and examples of the present invention are described above, the present invention is not limited to the before described embodiments and examples, and the present invention may be modified to various embodiments and examples within the technological scope defined by the accompanying claims and equivalents thereof.

claims:

1. A server apparatus having a function of creating a website on which advertisement information is automatically displayed, the server apparatus comprising:
a component database that stores a plurality of components constituting menus on the website, respectively;
a parameter database that stores a plurality of parameters constituting the menus on the website in combination with the respective components;
a website editing data generation processing unit that fetches selected components and selected parameters from the component database and the parameter database, respectively, that combines the selected components with the selected parameters, and that stores the combined components and parameters in a website editing data database as website editing data, based on information on the selected components from the component database and information on the selected parameters from the parameter database as parameters to be combined with the selected components, respectively, the both information being acquired in an information acquisition unit;
a website creation processing unit that converts the website editing data into an HTML document, that creates website information including the menus corresponding to the website editing data, and that stores the created website information in a website information database;
an advertisement insertion range creation processing unit that creates an advertisement insertion range included in the website, and that includes the advertisement insertion range in the created website information when the created website information is displayed during a website information creation processing performed by the website creation processing unit;
website display means that displays the website based on the created website information when the information acquisition unit acquires an access to the created website;
advertisement information acquisition request means that outputs advertisement acquisition request information through an information output unit so as to acquire advertisement information inserted into the advertisement insertion range when the information acquisition unit acquires the access to the created website; and
advertisement information display means that inserts the advertisement information acquired by the information acquisition unit into the advertisement insertion range on the displayed website, and that displays the advertisement information.

2. The server apparatus having a function of creating a website on which advertisement information is automatically displayed according to claim 1, further comprising terminal specifying means for specifying a type of a terminal that accesses the server apparatus when the information acquisition unit acquires the access to the website.

3. The server apparatus having a function of creating a website on which advertisement information is automatically displayed according to claim 2, further comprising terminal type information output means for adding information on the type of the terminal that accesses the server apparatus and that is specified by the terminal specifying means to the advertisement acquisition request information when the advertisement acquisition request information is output through the information output unit.

4. An advertisement information providing system comprising:
the server apparatus according to claim 1; and
a second server apparatus connected to the server apparatus through a network, the second server apparatus including:
a second advertisement information database that stores the advertisement information; and
advertisement information transmission and output means for transmitting the advertisement information stored in the second advertisement information database to the server apparatus that transmits the advertisement acquisition request information, based on the advertisement acquisition request information acquired by the information acquisition unit.

5. An advertisement information providing system comprising:
the server apparatus according to claim 2; and
a second server apparatus connected to the server apparatus through a network, the second server apparatus including:
a second advertisement information database that stores the advertisement information; and
advertisement information transmission and output means for transmitting the advertisement information stored in the second advertisement information database to the server apparatus that transmits the advertisement acquisition request information, based on the advertisement acquisition request information acquired by the information acquisition unit.

6. An advertisement information providing system comprising:
the server apparatus according to claim 3; and
a second server apparatus connected to the server apparatus through a network, the second server apparatus including:
a second advertisement information database that stores the advertisement information; and
advertisement information transmission and output means for transmitting the advertisement information stored in the second advertisement information database to the server apparatus that transmits the advertisement acquisition request information, based on the advertisement acquisition request information acquired by the information acquisition unit.

7. The advertisement information providing system according to claim 4, wherein
the server apparatus further includes a terminal type specifying information transfer processing unit that adds information for specifying a type of a terminal that accesses the server apparatus to the advertisement acquisition request information output from the information output unit when the information acquisition unit acquires the access to the website, and
the second server apparatus includes second terminal specifying means for specifying the type of the terminal that accesses the server apparatus, based on the information for specifying the type of the terminal that accesses the server apparatus, which information is added to the advertisement acquisition request information acquired by the information acquisition unit.

8. The advertisement information providing system according to claim 5, wherein
the server apparatus further includes a terminal type specifying information transfer processing unit that adds information for specifying a type of a terminal that accesses the server apparatus to the advertisement acquisition request information output from the information output unit when the information acquisition unit acquires the access to the website, and
the second server apparatus includes second terminal specifying means for specifying the type of the terminal that accesses the server apparatus, based on the information for specifying the type of the terminal that accesses the server apparatus, which information is added to the advertisement acquisition request information acquired by the information acquisition unit.

9. The advertisement information providing system according to claim 6, wherein
the server apparatus further includes a terminal type specifying information transfer processing unit that adds information for specifying a type of a terminal that accesses the server apparatus to the advertisement acquisition request information output from the information output unit when the information acquisition unit acquires the access to the web site, and
the second server apparatus includes second terminal specifying means for specifying the type of the terminal that accesses the server apparatus, based on the information for specifying the type of the terminal that accesses the server apparatus, which information is added to the advertisement acquisition request information acquired by the information acquisition unit.

10. The advertisement information providing system according to claim 4, wherein
the second server apparatus further comprises:
advertisement information extraction means for extracting the advertisement information corresponding to the type of the terminal from the second advertisement information database as the advertisement information to be transmitted by the advertisement information transmission and output means, based on the information on the type of the terminal added to the advertisement acquisition request information acquired by the information acquisition unit or on the information on the type of the terminal specified by the second terminal specifying means.

11. The advertisement information providing system according to claim 5, wherein
the second server apparatus further comprises:
advertisement information extraction means for extracting the advertisement information corresponding to the type of the terminal from the second advertisement information database as the advertisement information to be transmitted by the advertisement information transmission and output means, based on the information on the type of the terminal added to the advertisement acquisition request information acquired by the information acquisition unit or on the information on the type of the terminal specified by the second terminal specifying means.

12. The advertisement information providing system according to claim 6, wherein
the second server apparatus further comprises:
advertisement information extraction means for extracting the advertisement information corresponding to the type of the terminal from the second advertisement information database as the advertisement information to be transmitted by the advertisement information transmission and output means, based on the information on the type of the terminal added to the advertisement acquisition request information acquired by the information acquisition unit or on the information on the type of the terminal specified by the second terminal specifying means.

13. The advertisement information providing system according to claim 10, wherein
the server apparatus further comprises:
an advertisement information database that stores the advertisement information acquired from the second server apparatus; and
second advertisement information display means for inserting the advertisement information stored in the advertisement information database into the advertisement insertion range on the displayed website, and for displaying the advertisement information if the server apparatus cannot acquire the advertisement information although the advertisement information acquisition request means outputs the advertisement acquisition request information through the information output unit.

14. The advertisement information providing system according to claim 11, wherein
the server apparatus further comprises:
an advertisement information database that stores the advertisement information acquired from the second server apparatus; and
second advertisement information display means for inserting the advertisement information stored in the advertisement information database into the advertisement insertion range on the displayed website, and for displaying the advertisement information if the server apparatus cannot acquire the advertisement information although the advertisement information acquisition request means outputs the advertisement acquisition request information through the information output unit.

15. The advertisement information providing system according to claim 12, wherein
the server apparatus further comprises:
an advertisement information database that stores the advertisement information acquired from the second server apparatus; and
second advertisement information display means for inserting the advertisement information stored in the advertisement information database into the advertisement insertion range on the displayed website, and for displaying the advertisement information if the server apparatus cannot acquire the advertisement information although the advertisement information acquisition request means outputs the advertisement acquisition request information through the information output unit.

16. The advertisement information providing system according to claim 13, wherein
the second server apparatus is connected to a third server apparatus including a third advertisement information database that stores the advertisement information through the network, and
the second server apparatus includes advertisement information conversion means for converting the advertisement information acquired from the third server apparatus by the information acquisition unit so as to correspond to the website information displayed by the server apparatus, and for storing the converted advertisement information in the second advertisement information database when the information acquisition unit acquires the advertisement information from the third server apparatus.

17. The advertisement information providing system according to claim 14, wherein
the second server apparatus is connected to a third server apparatus including a third advertisement information database that stores the advertisement information through the network, and
the second server apparatus includes advertisement information conversion means for converting the advertisement information acquired from the third server apparatus by the information acquisition unit so as to correspond to the website information displayed by the server apparatus, and for storing the converted advertisement information in the second advertisement information database when the information acquisition unit acquires the advertisement information from the third server apparatus.

18. The advertisement information providing system according to claim 15, wherein
the second server apparatus is connected to a third server apparatus including a third advertisement information database that stores the advertisement information through the network, and
the second server apparatus includes advertisement information conversion means for converting the advertisement information acquired from the third server apparatus by the information acquisition unit so as to correspond to the website information displayed by the server apparatus, and for storing the converted advertisement information in the second advertisement information database when the information acquisition unit acquires the advertisement information from the third server apparatus.
